(19) United States
(12) Patent Application Publication
(10) Pub. No.: US 2014/0211475 A1
(43) Pub. Date: Jul. 31, 2014

(54) LIGHT BULB

(71) Applicant: EPISTAR CORPORATION, Hsinchu (TW)

(72) Inventors: Min-Hsun Hsieh, Hsinchu (TW); Wei-Chiang Hu, Hsinchu (TW)

(73) Assignee: EPISTAR CORPORATION, Hsinchu (TW)

(21) Appl. No.: 13/749,996

(22) Filed: Jan. 25, 2013

(51) Int. Cl. F21V 29/00

(52) U.S. Cl. CPC F21V 29/20
USPC 362/294; 362/382

(57) ABSTRACT

A light bulb includes: a light-emitting module; a heat-dissipation carrier including a first surface and a second surface opposite to the first surface, disposed under the light-emitting module for conducting heat generated by the light-emitting module away from the light-emitting module; and a heat radiator disposed above the heat-dissipation carrier for radiating heat away from the heat-dissipation carrier.

### TECHNICAL FIELD

The application relates to a light bulb, in particular, relates a light bulb having heat dissipation structure for dissipating heat from LED chip.

### DESCRIPTION OF BACKGROUND ART

The lighting theory and structure of light-emitting diode (LED) is different from that of conventional lighting source. LED has advantages as a low power loss, a long life-time, no need for warming time, and fast responsive time. Moreover, it is small, shockproof, suitable for mass production, and highly compatible with application demand for a tiny or array-type element so LEDs are widely adopted in various applications. For example, LEDs can be used in optical display apparatus, laser diodes, traffic lights, data storage devices, communication devices, illumination devices, medical devices, and so on.

LED light bulb has gradually expended the sector of lighting market due to the decrease of the selling price. An LED light bulb can be similar to a traditional incandescent bulb in appearance, but the design of an LED light bulb have to consider more aspects than that of an incandescent bulb, such as light-extraction, the arrangement of AC/DC converter, and heat-dissipation.

### SUMMARY OF THE DISCLOSURE

A light bulb includes: a light-emitting module; a heat-dissipation carrier including a first surface and a second surface opposite to the first surface, disposed under the light-emitting module for conducting heat generated by the light-emitting module away from the light-emitting module; and a heat radiator disposed above the heat-dissipation carrier for radiating heat away from the heat-dissipation carrier.

### BRIEF DESCRIPTION OF THE DRAWINGS

FIGS. 1A and 1B show a light bulb in accordance with a first embodiment of the present application.

FIG. 2 shows a light bulb in accordance with a second embodiment of the present application.

FIG. 3 shows a heat-dissipation structure for a light bulb in accordance with a third embodiment of the present application.

FIG. 4 shows a light bulb in accordance with a fourth embodiment of the present application.

### DETAILED DESCRIPTION OF PREFERRED EMBODIMENTS

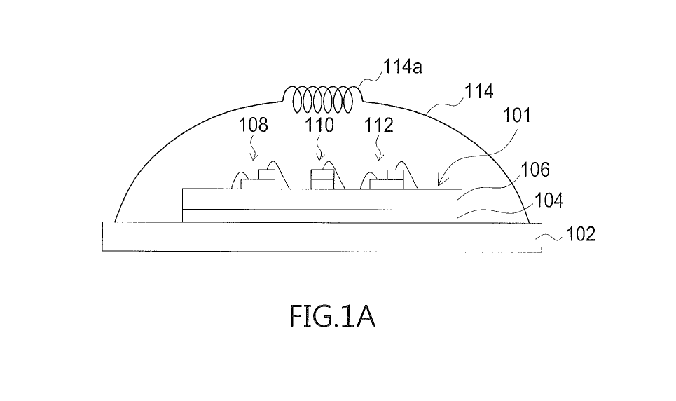

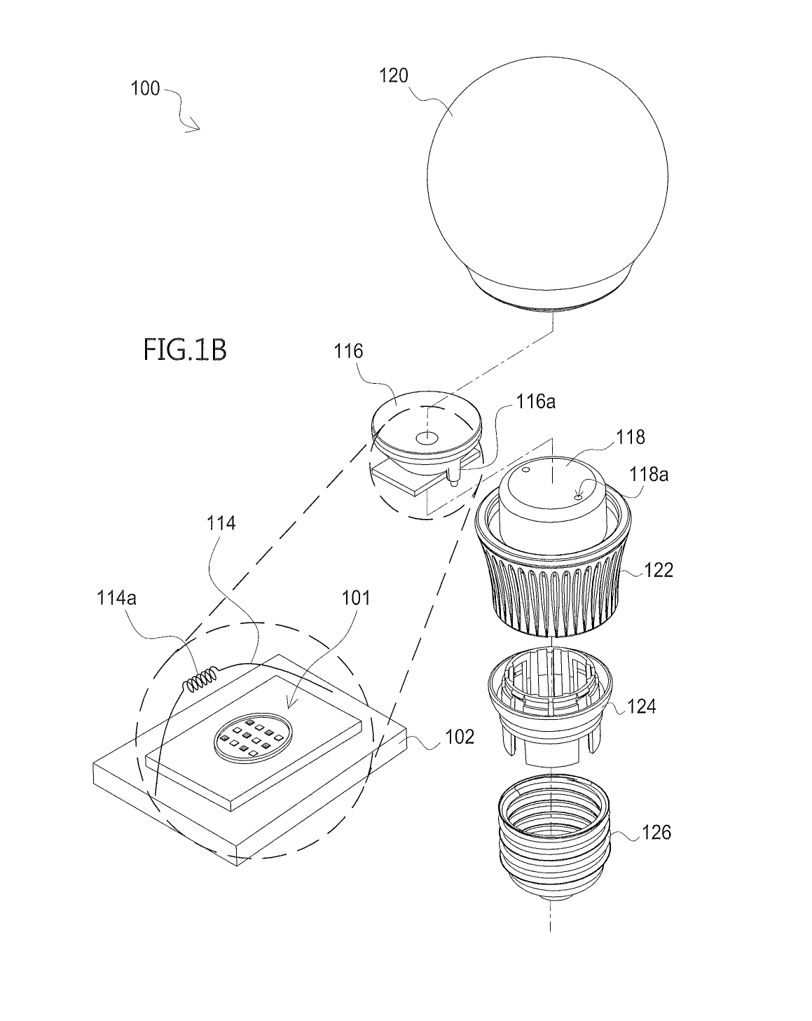

Referring to FIGS. 1A and 1B, a light bulb in accordance with a first embodiment of the present application is disclosed. As shown in FIG. 1A, a heat-dissipation carrier 102 carrying a light-emitting module 101 including a circuit board 116, and light-emitting chips 108, 110, and 112 disposed on the circuit board 116. The heat-dissipation carrier 102 can have high heat conductivity to absorb heat from the light-emitting module 101. A thermoelectric material 104 can be formed between the heat-dissipation carrier 102 and the circuit board 106 to enhance heat-transfer between the heat-dissipation carrier 102 and the circuit board 106. The thermoelectric figure of merit (ZT) of the thermoelectric material 104 can be larger than 0.5, wherein the thermoelectric material 104 includes Bi₂Te₃, CeAl₂, Y₂O₃, or SiGe. A heat radiator 114 in an arc form is connected to the heat-dissipation carrier 102 by two ends opposite to each other and has a coil section 114a above the LED module 101 for increasing heat-radiation area. The surface of the heat radiator 114 can be coated with a heat-radiating material (not shown) having emissivity larger than 0.7, therefore heat generated by the light-emitting module 101 can be firstly absorbed by the heat-dissipation carrier 102, then transferred to the heat radiator 114, finally out from the heat radiator 114 by heat radiation.

As shown in FIG. 1B, a light bulb 100 includes a cover 120, a lens 116, a lamp holder 118, a heat sink 122, a connecting part 124, and an electrical connector 126. The cover 120 can be hollow to accommodate the light-emitting module 101 and the heat radiator 114. The heat radiator 114 radiates heat in the cover 120. A conventional light bulb may have a heat-dissipation structure similar to the heat sink 122 surrounding the electrical connector for dissipating the operation heat of the electrical connector and light-emitting module, however, the light-emitting module is relatively far away from the heat sink so the heat-dissipation rate nearby the light-emitting module is low. In other words, the heat generated from optoelectronic conversion is difficult to be dissipated with the conventional light-dissipation structure of the light bulb. According to the heat radiator 114 of the present embodiment of the application, the heat of the light-emitting module can be radiated to the space inside the cover 120 efficiently.

The material of the heat dissipation carrier 102 can include Cu, Al or the alloy thereof. The material of the heat radiator 114 can be the same with that of the heat dissipation carrier 102. The material of the heat radiator 114 can be different from that of the heat dissipation carrier 102, and the material of the heat radiator 114 can have higher emissivity (ie. the scientific measurement of the ability for heat to radiate) than that of the material of the heat-dissipation carrier 102. The material of the heat-radiating material coated on the surface of the heat radiator 114 can include carbon-containing compound such as SiC, Graphene, metal oxide such as ZnO, or III-nitride compound such as BN.

The lens 116 is for adjusting the light-distribution of the light-emitting module 101. The lens 116 can have a first fixing part 116a being a shaft protruding from the bottom thereof, and the base 118 can have a second fixing part 118a corresponding to the first fixing part 116a. The second fixing part 118a can be an assembly hole of the base 118.

The epitaxy layers of the light-emitting chips 108, 110 and 112 can be formed in an MOCVD chamber and composed of materials such as the series of aluminum gallium indium phosphide (AlGaInP), the series of aluminum gallium indium nitride (AlGaInN), and/or the series of zinc oxide (ZnO), and the epitaxy layers of a light-emitting chip is for producing electrons and holes when receiving power. The electron and holes are then recombined to generate light. To be more specific, each of the light-emitting chips 108, 110 and 112 can have an active layer, and the active layer can be configured to be a single heterostructure (SH), a double heterostructure (DH), a double-side double heterostructure (DDH), or a multi-quantum well (MQW) structure to be a primary region for the recombination of electrons and holes to generate light.

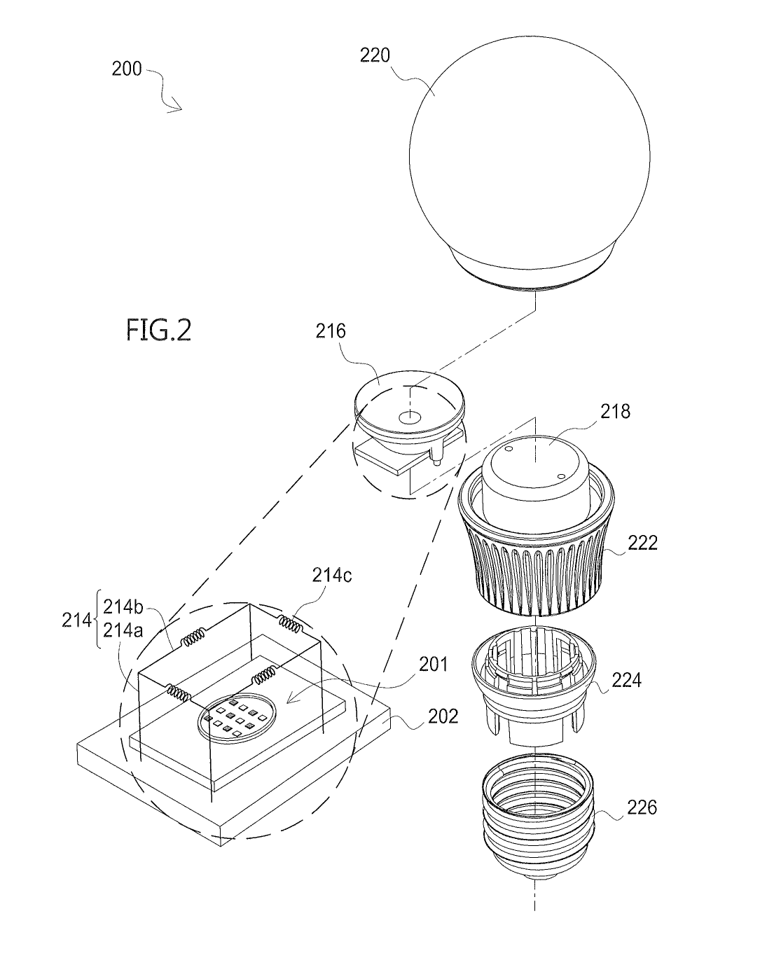

Referring to FIG. 2, a light bulb in accordance with a second embodiment of the present application is disclosed. A light bulb 200 includes: a cover 220; a lens 216; a lamp holder 218; a heat sink 222, a connecting part 224; an electrical connector 226; a light-emitting module 201; a heat-dissipation carrier 202; and a heat radiator 214. The structure of the light bulb 200 of the embodiment is similar to that of the first embodiment excepting the design of the heat radiator 214. The heat radiator 214 includes a plurality of supporting pillars 214a protruded from the heat-dissipation carrier 202 and surrounding the light-emitting module 201, and a plurality of wires 214b connecting the top ends of the supporting pillars 214a, and each wire 214b can include a coil section 214c. The heat radiator 214 of the embodiment offers more area for radiating heat, and the structure design of the heat radiator 214 can depend on the operation power or the estimated heat from the light-emitting module 201.

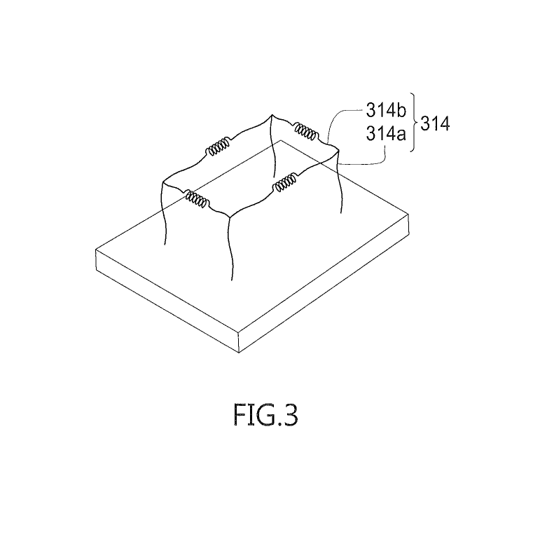

Referring to FIG. 3, a heat-dissipation structure of a light bulb in accordance with a third embodiment of the present application is disclosed. The embodiment can be similar to second embodiment, and the difference is that the supporting pillars 314a and the wire 314b can be curved-like to have more area for radiating heat.

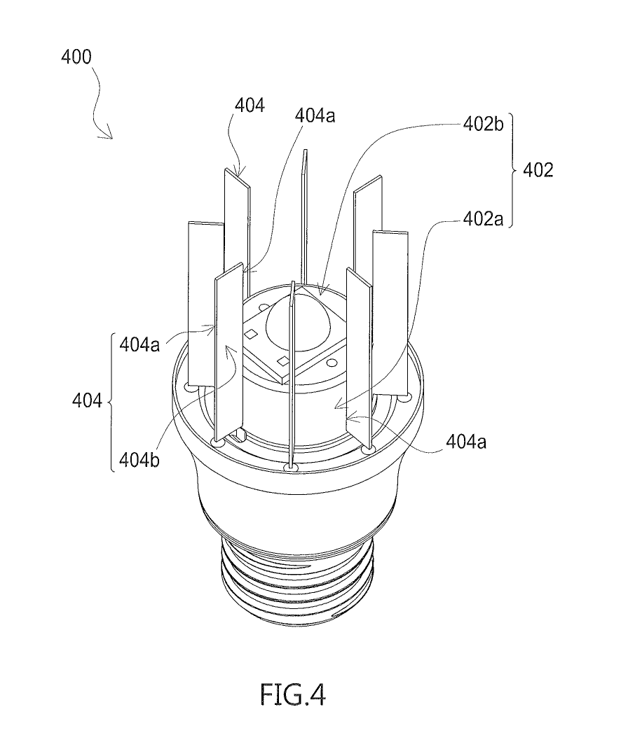

Referring to FIG. 4, a heat-dissipation structure for a light bulb in accordance with a fourth embodiment of the present application is disclosed. The light bulb 400 includes a heat-dissipation carrier 402, and a plurality of heat radiators 404 connected to the side surface 402a of the heat-dissipation carrier 402 and extended upward to surpass the top surface 402b of the heat-dissipation carrier 402. The heat-dissipation carrier 402 of the embodiment is thicker than that of the above embodiments so the heat radiators 404 can be disposed on the side surface 402a thereof. Preferably, the heat-dissipation carrier 402 can be integrated to the lamp holder of the light bulb 400. The heat radiators 404 can be a structure with multiple sheets surrounding the heat-dissipation carrier 402, and each sheet of the heat radiators 404 can have first surfaces 404a connected to the heat-dissipation carrier 402 and second surfaces 404b for dissipating heat therefrom. The area of Each second surface 404b is larger than the area of each first surface 404a.

Although the present application has been explained above, it is not the limitation of the range, the sequence in practice, the material in practice, or the method in practice. Any modification or decoration for present application is not detached from the spirit and the range of such.

1. A light bulb, comprising:
a light-emitting module;
a heat-dissipation carrier disposed under the light-emitting module for conducting heat generated by the light-emitting module away from the light-emitting module; and
a heat radiator disposed above the heat-dissipation carrier for radiating heat away from the heat-dissipation carrier, wherein the heat radiator crosses over the light-emitting module and has two opposite ends connected to the heat-dissipation carrier.

2. The light bulb according to claim 1, wherein the heat radiator is in form of an arc.

3. The light bulb according to claim 2, wherein the heat radiator has a coil section above the light-emitting module.

4. The light bulb according to claim 1, wherein the heat radiator is coated with a heat-radiating material having emissivity larger than 0.7.

5. The light bulb according to claim 4, wherein the heat-radiating material comprises carbon-containing compound, metal oxide, or III-nitride compound.

6. The light bulb according to claim 5, wherein the heat-radiating material comprises SiC, Graphene, ZnO, or BN.

7. The light bulb according to claim 1, wherein the heat radiator comprises a plurality of supporting pillars protruded from the heat-dissipation carrier, and a plurality of wires connecting between the top ends of the supporting pillars.

8. The light bulb according to claim 1, wherein the heat radiator comprises opaque material.

9. The light bulb according to claim 1, wherein the light-emitting module comprises a circuit board and a plurality of LED chips disposed on the circuit board.

10. The light bulb according to claim 9, further comprising a lens above the light-emitting module.

11. The light bulb according to claim 10, further comprising: a thermoelectric material formed between the circuit board and the heat dissipation carrier, and the thermoelectric material has thermoelectric figure of merit (ZT) larger than 0.5; and a holder on which the heat-dissipation carrier is disposed, wherein the holder comprises a first fixing part, and the lens comprises a second fixing part fixed to the first fixing part.

12. The light bulb according to claim 11, wherein the thermoelectric material comprises Bi₂Te₃, CeAl₂, Y₂O₃ or SiGe.

13. A light bulb, comprising:
a light-emitting module;
a heat-dissipation carrier disposed under the light-emitting module for conducting heat generated by the light-emitting module away from the light-emitting module;
a heat radiator disposed above the heat-dissipation carrier for radiating heat away from the heat-dissipation carrier; and
a cover, which is hollow to accommodate the light-emitting module and the heat radiator disposed therein, and the heat radiator disposed in an inner space between the cover and the heat-dissipation carrier.

14. The light bulb according to claim 1, wherein the material of the heat-dissipation carrier comprises Al, Cu, or the alloy thereof.

15. The light bulb according to claim 1, wherein the emissivity of the heat radiator is higher than that of the heat-dissipation carrier.

16. (canceled)

17. The light bulb according to claim 1, further comprising a lens fixing to the top surface of the heat-dissipation carrier.

18. (canceled)

19. (canceled)

20. (canceled) 3390239
